(19) United States
(12) Patent Application Publication
(10) Pub. No.: US 2025/0214841 A1
(43) Pub. Date: Jul. 3, 2025

(54) PREPARATION METHOD FOR AMMONIUM MANGANESE IRON PHOSPHATE, AND LITHIUM MANGANESE IRON PHOSPHATE AND USE THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN)

(72) Inventors: Haijun Yu, Foshan, Guangdong (CN); Yinghao Xie, Foshan, Guangdong (CN); Aixia Li, Foshan, Guangdong (CN); Xuemei Zhang, Foshan, Guangdong (CN); Changdong Li, Foshan, Guangdong (CN)

(21) Appl. No.: 18/849,553

(22) PCT Filed: Sep. 20, 2022
(86) PCT No.: PCT/CN2022/119985

§ 371 Date: Sep. 23, 2024

(30) Foreign Application Priority Data
Jun. 28, 2022 (CN) 202210741388.5

(51) Int. Cl. C01B 25/45; H01M 4/58; H01M 10/0525

(52) U.S. Cl. CPC C01B 25/451; H01M 4/5825; H01M 10/0525; C01P 2004/03; C01P 2004/61; C01P 2006/40

(57) ABSTRACT

Disclosed is a preparation method for ammonium manganese iron phosphate. The preparation method comprises: respectively mixing a mixed salt solution of metals and an ammonium dihydrogen phosphate solution with an organic solution to obtain a mixed liquor of metal salts and a mixed liquor of phosphate; concurrently adding the mixed liquor of metal salts, the mixed liquor of phosphate and a first ammonia water into a base solution for reaction; and carrying out solid-liquid separation to obtain ammonium manganese iron phosphate. A mixed metal salt solution of a ferrous source and a manganese source and a phosphorus source are subjected to a coprecipitation reaction in an organic phase, to synthesize large-particle ammonium manganese iron phosphate with high compaction density. After the ammonium manganese iron phosphate is mixed with a lithium source and a carbon source, sintering can be carried out to prepare a lithium manganese iron phosphate cathode material.

### FIELD

The present disclosure belongs to the technical field of cathode materials for lithium batteries, and in particular relates to a preparation method for ammonium manganese iron phosphate, lithium manganese iron phosphate and use thereof.

### BACKGROUND

Compared with ternary batteries, lithium iron phosphate batteries have advantages of higher safety and lower cost. They have the advantages of good thermal stability, long cycle life, environmental friendliness, and rich sources of raw materials. Lithium iron phosphate is currently the most potential cathode material for lithium-ion traction batteries, and is gaining the favor of more automobile manufacturers, with an increasing market share. Lithium iron phosphate has a relatively regular olivine structure, which enables lithium iron phosphate to obtain the advantages of large discharge capacity, low price, non-toxicity, and less pollution to the environment. Therefore, research on lithium iron phosphate has been popular in recent years.

Despite these advantages, when used in batteries, lithium iron phosphate has the disadvantages of lower electronic conductivity, smaller lithium ion diffusion coefficient, and lower compaction density due to the limitation of its structure, which greatly limits the application of lithium iron phosphate. In order to broaden the application of lithium iron phosphate, introducing manganese-based compounds into lithium iron phosphate to form a solid solution of lithium manganese iron phosphate is currently adopted. Since the manganese-based compounds have higher electrochemical reaction voltage and better electrolyte compatibility, the solid solution of lithium manganese iron phosphate can obtain better electric capacity and cycle effect.

At present, there are many synthetic methods of lithium manganese iron phosphate basically similar to the synthesis of lithium iron phosphate, such as a complete solid-phase method comprising directly sintering a phosphorus source, an iron source, a manganese source, a lithium source and other raw materials to obtain lithium manganese iron phosphate, or a method comprising synthesizing manganese phosphate as a manganese source and a part of phosphorus source first, then mixing the manganese phosphate, an iron source and a lithium source, and sintering a mixture to obtain lithium manganous iron phosphate. The disadvantage is that manganese and iron are unable to be uniformly mixed at the atomic level, and the prepared lithium manganese iron phosphate has unsatisfied charging performance at constant voltage stage and poor rate discharge performance. In addition, trivalent manganese is prone to disproportionation reaction in solution to generate divalent manganese and tetravalent manganese, resulting in low product purity. Lithium manganese iron phosphate can also be prepared by the hydrothermal method, but the cost is high because the amount of lithium used is three times the theoretical amount. Moreover, the high-temperature and high-pressure equipment used results in high equipment investment, making the overall cost much higher than that of the solid-phase method.

Furthermore, in the related art, lithium manganese iron phosphate usually has a compaction density of 2.1-2.2 g/cm³ and a specific capacity of 135-150 mAh/g, which cannot meet the requirements of the traction battery manufacturers who urgently need to increase energy density.

### SUMMARY

The present disclosure aims to solve at least one of the above-mentioned technical problems existing in the prior art. For this purpose, the present disclosure provides a preparation method for ammonium manganese iron phosphate, a lithium manganese iron phosphate and use thereof.

According to one aspect of the present disclosure, a method for preparing ammonium manganese iron phosphate is provided, comprising steps of:

S1: mixing a mixed salt solution of metals and an ammonium dihydrogen phosphate solution with an organic solution respectively to obtain a mixed liquor of metal salts and a mixed liquor of phosphate, wherein the mixed salt solution of metals is a mixed solution of a manganese salt and a ferrous salt, and the organic solution is obtained by dissolving a surfactant in an organic solvent; and

S2: under an inert atmosphere, adding the mixed liquor of metal salts, the mixed liquor of phosphate and a first ammonia water in parallel to a base solution for reaction, and when a reaction product reaches a target particle size, performing solid-liquid separation to obtain the ammonium manganese iron phosphate, wherein the base solution is a mixture of the mixed liquor of phosphate and a second ammonia water.

In some embodiments of the present disclosure, in step S1, the ferrous salt is selected from the group consisting of ferrous sulfate, ferrous chloride and a mixture thereof.

In some embodiments of the present disclosure, in step S1, the manganese salt is selected from the group consisting of manganese sulfate, manganese chloride and a mixture thereof.

In some embodiments of the present disclosure, in step S1, the molar ratio of iron element to manganese element in the mixed salt solution of metals is (0.25-9):1, the total concentration of metal ions in the mixed salt solution of metals is 0.5-1.0 mol/L, and the volume ratio of the mixed salt solution of metals to the organic solution in the mixed liquor of metal salts is (1-5):100.

In some embodiments of the present disclosure, in step S1, the concentration of the ammonium dihydrogen phosphate solution is 0.5-1.0 mol/L, and the volume ratio of the ammonium dihydrogen phosphate solution to the organic solution in the mixed liquor of phosphate is (1-5):100.

In some embodiments of the present disclosure, in step S1, the ratio of the mass of the surfactant to the volume of the organic solvent is (2-8) g:100 mL.

In some embodiments of the present disclosure, in step S1, the surfactant is selected from the group consisting of CTAB, DBS, SDBS, PEG-400 and a mixture thereof.

In some embodiments of the present disclosure, in step S1, the organic solvent is prepared by mixing cyclohexane and n-butanol at a volume ratio of (8-9):(1-2).

In some embodiments of the present disclosure, in step S2, the base solution has a pH of 8-9, and a system is controlled to have a pH of 8-9 in the reaction.

In some embodiments of the present disclosure, in step S2, the concentration of the first ammonia water is 8.0-12.0 mol/L.

In some embodiments of the present disclosure, in step S2, the reaction is performed at a stirring speed of 200-350 r/min.

In some embodiments of the present disclosure, in step S2, a temperature for the reaction is controlled to be 20-40° C.

In some embodiments of the present disclosure, in step S2, the target particle size of the reaction product is 5-15 μm.

The present disclosure also provides a lithium manganese iron phosphate, which is prepared by calcining the ammonium manganese iron phosphate prepared by the method with a lithium source and a carbon source.

In some embodiments of the present disclosure, the ammonium manganese iron phosphate is pre-pulverized into powder with a particle size of 2-5 μm.

In some embodiments of the present disclosure, the molar ratio of the ammonium manganese iron phosphate, to the lithium source and to the carbon source, (Fe+Mn):Li:carbon source, is 1:(1.0-1.2):(0.3-0.5).

In some embodiments of the present disclosure, the carbon source is selected from the group consisting of glucose, sucrose and a mixture thereof.

In some embodiments of the present disclosure, the lithium source is selected from the group consisting of lithium carbonate, lithium hydroxide and a mixture thereof.

In some embodiments of the present disclosure, before the calcination, the method further comprises dispersing the ammonium manganese iron phosphate, the lithium source and the carbon source in water, and then performing spray-drying.

In some embodiments of the present disclosure, the amount of the water used is 20%-35% of the total mass of the ammonium manganese iron phosphate, the lithium source and the carbon source.

In some embodiments of the present disclosure, the calcination process is calcining at 600-850° C. for 6-20 h under the protection of an inert gas.

The present disclosure also provides use of the lithium manganese iron phosphate in preparation of a lithium-ion battery.

According to a preferred embodiment of the present disclosure, the present disclosure has at least the following beneficial effects.

1. By the co-precipitation of a mixed metal salt solution of a ferrous source and a manganese source with a phosphorus source in an organic phase, the present disclosure prepares an ammonium manganese iron phosphate with large particle size and high compaction density. After mixing the ammonium manganese iron phosphate with a lithium source and a carbon source followed by sintering, a finished product of a lithium manganese iron phosphate cathode material can be prepared. The reaction equations are as follows:

Co-precipitation reaction:

NH₄⁺+xFe²⁺⁺(1−x)Mn²⁺+PO₄³⁻→NH₄FeₓMn₍₁₋ₓ₎PO₄; and

Calcination reaction:

LiOH+NH₄FeₓMn₍₁₋ₓ₎PO₄→NH₃+LiFeₓMn(1−x)PO₄+H₂O.

2. In the preparation of the precursor ammonium manganese iron phosphate according to the present disclosure, on the one hand, the feature that it is more difficult for ammonium manganese iron phosphate to be dissolved in the organic phase is utilized to allow the solution to quickly reach supersaturation and quickly form crystal nuclei; and on the other hand, pH of the reaction system is controlled and phosphate is used as the base solution to provide sufficient phosphate ions. As the crystal nucleus grows, it can grow slowly under the induction of a surfactant to form a dense particle structure, and with the addition of materials, the particles gradually grow up to form large particle morphology. With the slow growth of the particles, the larger the particle size is, the denser the structure is, so that the cathode material prepared by the following sintering can well inherit the morphology characteristics of the precursor, thereby improving the compaction density of the cathode material.

3. The ammonium manganese iron phosphate is used as the precursor, in which iron is divalent iron, so no further reduction is required during sintering, which reduces the amount of carbon source used. In addition, the ammonium radical therein is released in the form of ammonia gas, which is beneficial to the formation of a porous channel structure of the cathode material. The porous channel structure is conducive to the infiltration of the cathode material and the electrolyte, and improves the deintercalation/intercalation efficiency of lithium ions.

### BRIEF DESCRIPTION OF DRAWINGS

The present disclosure will be further described below in conjunction with the drawings and examples, wherein:

FIG. 1 is an SEM image of the ammonium manganese iron phosphate prepared in Example 1 of the present disclosure; and

FIG. 2 is an SEM image of the lithium manganese iron phosphate prepared in Example 1 of the present disclosure.

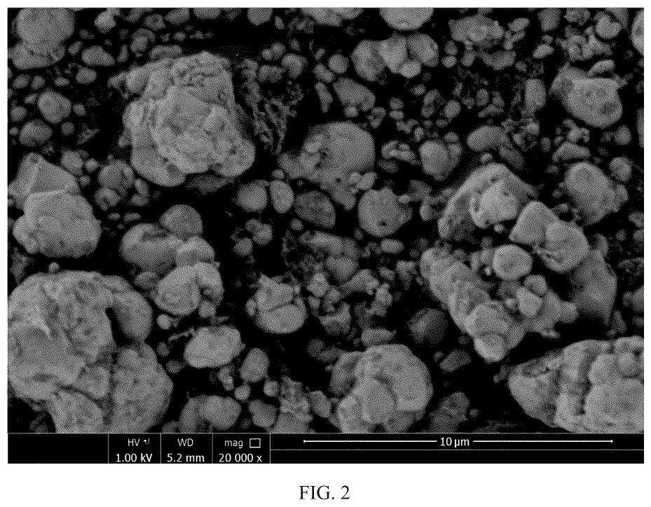

### DETAILED DESCRIPTION

The concept of the present disclosure and the technical effects produced by the present disclosure will be clearly and completely described below in conjunction with the examples, so as to fully understand the purpose, features and effects of the present disclosure. It is apparent that the described examples are only a part of the examples of the present disclosure, rather than all of them. All the other examples obtained by those skilled in the art based on the examples of the present disclosure without any creative work fall into the scope of protection of the present disclosure,

### Example 1

In this example, a lithium manganese iron phosphate was prepared. The specific process was as follows.

A method for preparing a lithium manganese iron phosphate with large particle size and high compaction density and a precursor thereof comprised the following steps.

Step 1: A mixed salt solution of metals of manganese chloride and ferrous chloride with a total concentration of metal ions of 1.0 mol/L was prepared at a molar ratio of iron element to manganese element of 1:1.

Step 2: An ammonium dihydrogen phosphate solution with a concentration of 1.0 mol/L was prepared.

Step 3: An organic solvent was prepared with cyclohexane and n-butanol at a volume ratio of 8:1.

Step 4: A surfactant was dissolved in the organic solvent at a ratio of the surfactant to the organic solvent of 5 g:100 mL to obtain an organic solution, wherein the surfactant was CTAB.

Step 5: The mixed salt solution of metals and the ammonium dihydrogen phosphate solution were respectively mixed with the organic solution at a volume ratio of 5 mL:100 mL to obtain a mixed liquor of metal salts and a mixed liquor of phosphate.

Step 6: The mixed liquor of phosphate was added with ammonia water with a concentration of 12.0 mol/L to adjust the pH to 9 to obtain a base solution.

Step 7: Under a nitrogen atmosphere, the mixed liquor of metal salts, the mixed liquor of phosphate, and the ammonia water with a concentration of 12.0 mol/L were added in parallel to a reactor containing the base solution. In the reactor, the temperature was controlled to be 20° C., the pH was controlled to be 8.5, and the stirring speed was controlled to be 350 r/min.

Step 8: When the D50 of the material in the reactor was detected to reach 15 μm, the feeding was stopped, and the solid-liquid separation was performed. Then, the obtained material was washed with deionized water followed by anhydrous ethanol to obtain ammonium manganese iron phosphate.

Step 9: The ammonium manganese iron phosphate was pulverized into powder with a particle size of 2-5 μm.

Step 10: The pulverized ammonium manganese iron phosphate was mixed with lithium hydroxide and glucose at a molar ratio of (Fe+Mn):Li:carbon source of 1:1.1:0.3, added with deionized water in an amount of 35% of the total mass of ammonium manganese iron phosphate, lithium hydroxide and glucose, mixed well, and spray-dried.

Step 11: Under the protection of an inert gas, a solid obtained after spray-drying was calcined at 850° C. for 14 h, and then cooled to room temperature naturally to obtain a finished product of a lithium manganese iron phosphate cathode material.

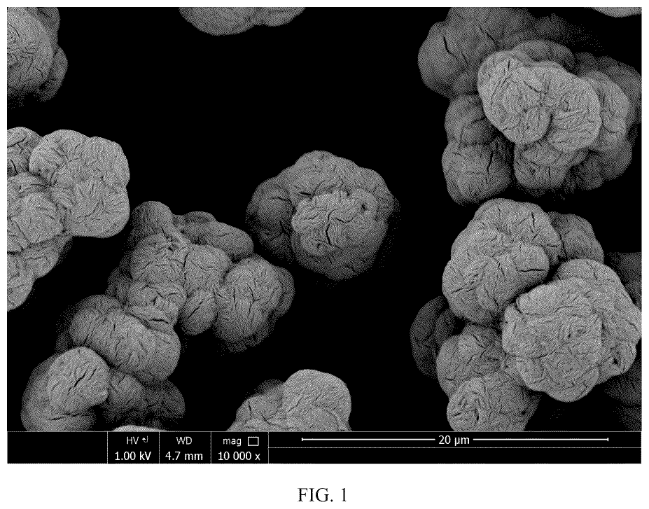

FIG. 1 is an SEM image of the ammonium manganese iron phosphate prepared in this example, and it can be seen from the figure that the particles of the precursor have a very dense structure,

### Example 2

In this example, a lithium manganese iron phosphate was prepared. The specific process was as follows.

A method for preparing a lithium manganese iron phosphate with large particle size and high compaction density and a precursor thereof comprised the following steps.

Step 1: A mixed salt solution of metals of manganese sulfate and ferrous sulfate with a total concentration of metal ions of 0.5 mol/L was prepared at a molar ratio of iron element to manganese element of 1:1.

Step 2: An ammonium dihydrogen phosphate solution with a concentration of 0.5 mol/L was prepared.

Step 3: An organic solvent was prepared with cyclohexane and n-butanol at a volume ratio of 8:1.

Step 4: A surfactant was dissolved in the organic solvent at a ratio of the surfactant to the organic solvent of 2 g:100 mL to obtain an organic solution, wherein the surfactant was SDBS.

Step 5: The mixed salt solution of metals and the ammonium dihydrogen phosphate solution were respectively mixed with the organic solution at a volume ratio of 1 mL:100 mL to obtain a mixed liquor of metal salts and a mixed liquor of phosphate.

Step 6: The mixed liquor of phosphate was added with ammonia water with a concentration of 8.0 mol/L to adjust the pH to 8.5 to obtain a base solution.

Step 7: Under a nitrogen atmosphere, the mixed liquor of metal salts, the mixed liquor of phosphate, and the ammonia water with a concentration of 8.0 mol/L were added in parallel to a reactor containing the base solution. In the reactor, the temperature was controlled to be 30° C., the pH was controlled to be 8.0, and the stirring speed was controlled to be 200 r/min.

Step 8: When the D50 of the material in the reactor was detected to reach 5 μm, the feeding was stopped, and the solid-liquid separation was performed. Then, the obtained material was washed with deionized water followed by anhydrous ethanol to obtain ammonium manganese iron phosphate.

Step 9: The ammonium manganese iron phosphate was pulverized into powder with a particle size of 2-5 μm.

Step 10: The pulverized ammonium manganese iron phosphate was mixed with lithium carbonate and sucrose at a molar ratio of (Fe+Mn):Li:carbon source of 1:1.0:0.3, added with deionized water in an amount of 20% of the total mass of ammonium manganese iron phosphate, lithium carbonate and sucrose, mixed well, and spray-dried.

Step 11: Under the protection of an inert gas, a solid obtained after spray-drying was calcined at 600° C. for 20 h, and then cooled to room temperature naturally to obtain a finished product of a lithium manganese iron phosphate cathode material.

### Example 3

In this example, a lithium manganese iron phosphate was prepared. The specific process was as follows.

A method for preparing a lithium manganese iron phosphate with large particle size and high compaction density and a precursor thereof comprised the following steps.

Step 1: A mixed salt solution of metals of manganese chloride and ferrous chloride with a total concentration of metal ions of 0.8 mol/L was prepared at a molar ratio of iron element to manganese element of 1:1.

Step 2: An ammonium dihydrogen phosphate solution with a concentration of 0.8 mol/L was prepared.

Step 3: An organic solvent was prepared with cyclohexane and n-butanol at a volume ratio of 8:1.

Step 4: A surfactant was dissolved in the organic solvent at a ratio of the surfactant to the organic solvent of 5 g:100 mL to obtain an organic solution, wherein the surfactant was PEG-400.

Step 5: The mixed salt solution of metals and the ammonium dihydrogen phosphate solution were respectively mixed with the organic solution at a volume ratio of 2.5 mL:100 mL to obtain a mixed liquor of metal salts and a mixed liquor of phosphate.

Step 6: The mixed liquor of phosphate was added with ammonia water with a concentration of 10.0 mol/L to adjust the pH to 8.0 to obtain a base solution.

Step 7: Under a nitrogen atmosphere, the mixed liquor of metal salts, the mixed liquor of phosphate, and the ammonia water with a concentration of 10.0 mol/L were added in parallel to a reactor containing the base solution. In the reactor, the temperature was controlled to be 40° C., the pH was controlled to be 8.0, and the stirring speed was controlled to be 300 r/min.

Step 8: When the D50 of the material in the reactor was detected to reach 10 μm, the feeding was stopped, and the solid-liquid separation was performed. Then, the obtained material was washed with deionized water followed by anhydrous ethanol to obtain ammonium manganese iron phosphate.

Step 9: The ammonium manganese iron phosphate was pulverized into powder with a particle size of 2-5 μm.

Step 10: The pulverized ammonium manganese iron phosphate was mixed with lithium hydroxide and glucose at a molar ratio of (Fe+Mn):Li:carbon source of 1:1.1:0.4, added with deionized water in an amount of 25% of the total mass of ammonium manganese iron phosphate, lithium hydroxide and glucose, mixed well, and spray-dried.

Step 11: Under the protection of an inert gas, a solid obtained after spray-drying was calcined at 750° C. for 16 h, and then cooled to room temperature naturally to obtain a finished product of a lithium manganese iron phosphate cathode material.

### Comparative Example 1

In this comparative example, a lithium manganese iron phosphate was prepared. The specific process was as follows and differed from Example 1 in that no organic solution was added.

Step 1: A mixed salt solution of metals of manganese chloride and ferrous chloride with a total concentration of metal ions of 0.05 mol/L was prepared at a molar ratio of iron element to manganese element of 1:1.

Step 2: An ammonium dihydrogen phosphate solution with a concentration of 0.05 mol/L was prepared.

Step 3: Ammonia water with a concentration of 12.0 mol/L was prepared.

Step 4: The ammonium dihydrogen phosphate solution was added with ammonia water with a concentration of 12.0 mol/L to adjust the pH to 9 to obtain a base solution.

Step 5: Under a nitrogen atmosphere, the mixed salt solution of metals, the ammonium dihydrogen phosphate solution, and the ammonia water with a concentration of 12.0 mol/L were added in parallel to a reactor containing the base solution. In the reactor, the temperature was controlled to be 20° C., the pH was controlled to be 8.5, and the stirring speed was controlled to be 350 r/min.

Step 6: When the D50 of the material in the reactor was detected to reach 15 μm, the feeding was stopped, and the solid-liquid separation was performed. Then, the obtained material was washed with deionized water followed by anhydrous ethanol to obtain ammonium manganese iron phosphate.

Step 7: The ammonium manganese iron phosphate was pulverized into powder with a particle size of 2-5 μm.

Step 8: The pulverized ammonium manganese iron phosphate was mixed with lithium hydroxide and glucose at a molar ratio of (Fe+Mn):Li:carbon source of 1:1.1:0.3, added with deionized water in an amount of 35% of the total mass of ammonium manganese iron phosphate, lithium hydroxide and glucose, mixed well, and spray-dried.

Step 9: Under the protection of an inert gas, a solid obtained after spray-drying was calcined at 850° C. for 14 h, and then cooled to room temperature naturally to obtain a finished product of a lithium manganese iron phosphate cathode material.

### Comparative Example 2

In this comparative example, a lithium manganese iron phosphate was prepared. The specific process was as follows and differed from Example 2 in that no organic solution was added.

Step 1: A mixed salt solution of metals of manganese sulfate and ferrous sulfate with a total concentration of metal ions of 0.005 mol/L was prepared at a molar ratio of iron element to manganese element of 1:1.

Step 2: An ammonium dihydrogen phosphate solution with a concentration of 0.005 mol/L was prepared.

Step 3: Ammonia water with a concentration of 8.0 mol/L was prepared.

Step 4: The ammonium dihydrogen phosphate solution was added with ammonia water with a concentration of 8.0 mol/L to adjust the pH to 8.5 to obtain a base solution.

Step 5: Under a nitrogen atmosphere, the mixed salt solution of metals, the ammonium dihydrogen phosphate solution, and the ammonia water with a concentration of 8.0 mol/L were added in parallel to a reactor containing the base solution. In the reactor, the temperature was controlled to be 30° C., the pH was controlled to be 8.0, and the stirring speed was controlled to be 200 r/min.

Step 6: When the D50 of the material in the reactor was detected to reach 5 μm, the feeding was stopped, and the solid-liquid separation was performed. Then, the obtained material was washed with deionized water followed by anhydrous ethanol to obtain ammonium manganese iron phosphate.

Step 7: The ammonium manganese iron phosphate was pulverized into powder with a particle size of 2-5 μm.

Step 8: The pulverized ammonium manganese iron phosphate was mixed with lithium carbonate and sucrose at a molar ratio of (Fe+Mn):Li:carbon source of 1:1.0:0.3, added with deionized water in an amount of 20% of the total mass of ammonium manganese iron phosphate, lithium carbonate and sucrose, mixed well, and spray-dried.

Step 9: Under the protection of an inert gas, a solid obtained after spray-drying was calcined at 600° C. for 20 h, and then cooled to room temperature naturally to obtain a finished product of a lithium manganese iron phosphate cathode material.

### Comparative Example 3

In this comparative example, a lithium manganese iron phosphate was prepared. The specific process was as follows and differed from Example 3 in that no organic solution was added:

Step 1: A mixed salt solution of metals of manganese chloride and ferrous chloride with a total concentration of metal ions of 0.02 mol/L was prepared at a molar ratio of iron element to manganese element of 1:1.

Step 2: An ammonium dihydrogen phosphate solution with a concentration of 0.02 mol/L was prepared.

Step 3: Ammonia water with a concentration of 10.0 mol/L was prepared.

Step 4: The ammonium dihydrogen phosphate solution was added with ammonia water with a concentration of 10.0 mol/L to adjust the pH to 8.0 to obtain a base solution.

Step 5: Under a nitrogen atmosphere, the mixed salt solution of metals, the ammonium dihydrogen phosphate solution, and the ammonia water with a concentration of 10.0 mol/L were added in parallel to a reactor containing the base solution. In the reactor, the temperature was controlled to be 40° C., the pH was controlled to be 8.0, and the stirring speed was controlled to be 300 r/min.

Step 6: When the D50 of the material in the reactor was detected to reach 10 μm, the feeding was stopped, and the solid-liquid separation was performed. Then, the obtained material was washed with deionized water followed by anhydrous ethanol to obtain ammonium manganese iron phosphate.

Step 7: The ammonium manganese iron phosphate was pulverized into powder with a particle size of 2-5 μm.

Step 8: The pulverized ammonium manganese iron phosphate was mixed with lithium hydroxide and glucose at a molar ratio of (Fe+Mn):Li:carbon source of 1:1.1:0.4, added with deionized water in an amount of 25% of the total mass of ammonium manganese iron phosphate, lithium hydroxide and glucose, mixed well, and spray-dried.

Step 9: Under the protection of an inert gas, a solid obtained after spray-drying was calcined at 750° C. for 16 h, and then cooled to room temperature naturally to obtain a finished product of a lithium manganese iron phosphate cathode material.

TABLE 1
Compaction density of Examples and Comparative Examples

| | Compaction density g/cm³ |
|---|---|
| Example 1 | 2.68 |
| Example 2 | 2.66 |
| Example 3 | 2.66 |
| Comparative Example 1 | 2.14 |
| Comparative Example 2 | 2.13 |
| Comparative Example 3 | 2.16 |

### Test example

The lithium manganese iron phosphates obtained in Examples and Comparative Examples as the cathode material, acetylene black as the conductive agent, and PVDF as the binding agent, were mixed at a mass ratio of 8:1:1, then added with a certain amount of organic solvent NMP, stirred, and then coated on an aluminum foil to prepare the positive electrode sheet. The metal lithium sheet was used as the negative electrode, and Celgard2400 polypropylene porous film was used as the separator. For the electrolyte, the solvent was a solution consisting of EC, DMC and EMC at a mass ratio of 1:1:1, and the solute was LiPF₆ with a concentration of 1.0 mol/L. A 2023 button battery was assembled in a glove box. The battery was tested for the charge-discharge cycle performance to measure the specific discharge capacity at 0.2 C and 1 C within the cut-off voltage range of 2.2-4.3 V. The results of the electrochemical performance were shown in Table 2.

TABLE 2

| | Discharge | Discharge | Capacity |
|---|---|---|---|
| | capacity | capacity | retention rate |
| | at 0.2 C, | a t1 C, | after 600 |
| | mAh/cm³ | mAh/cm³ | cycles at 1 C |
| Example 1 | 382.56 | 300.24 | 95.3% |
| Example 2 | 380.88 | 300.22 | 94.9% |
| Example 3 | 381.36 | 299.28 | 94.8% |
| Comparative Example 1 | 284.83 | 219.78 | 83.6% |
| Comparative Example 2 | 279.88 | 222.16 | 86.7% |
| Comparative Example 3 | 285.55 | 222.70 | 84.3% |

From Tables 1 and 2, it can be seen that the compaction density of Examples is significantly higher than that of Comparative Examples, reaching 2.6 g/cm³ or more. The increase in the compaction density improves the discharge capacity. The reason for this change is that in Comparative Examples, the preparation method was the traditional aqueous-phase method, and the primary particles in the obtained secondary particles had a relatively loose structure, and were prone to be separated at the carbonization of the carbon source while being mixed with the carbon source during the subsequent sintering, which made it difficult for them to be agglomerated and crystallized, resulting in loose particle structure and lower density after sintering. By the method of the present disclosure, a highly dense particle structure can be formed, thereby improving the compaction density.

The examples of the present disclosure have been described in detail above in conjunction with the drawings. However, the present disclosure is not limited to the above-mentioned examples, and various modifications can be made without departing from the purpose of the present disclosure within the scope of knowledge possessed by those of ordinary skill in the art. In addition, in the case of no conflict, the examples of the present disclosure and the features in the examples may be combined with each other.

1. A method for preparing ammonium manganese iron phosphate, comprising steps of:
S1: mixing a mixed salt solution of metals and an ammonium dihydrogen phosphate solution with an organic solution respectively to obtain a mixed liquor of metal salts and a mixed liquor of phosphate, wherein the mixed salt solution of metals is a mixed solution of a manganese salt and a ferrous salt, and the organic solution is obtained by dissolving a surfactant in an organic solvent; and
S2: under an inert atmosphere, adding the mixed liquor of metal salts, the mixed liquor of phosphate and a first ammonia water in parallel to a base solution for reaction, and when a reaction product reaches a target particle size, performing solid-liquid separation to obtain the ammonium manganese iron phosphate, wherein the base solution is a mixture of the mixed liquor of phosphate and a second ammonia water.

2. The method according to claim 1, wherein in step S1, a molar ratio of iron element to manganese element in the mixed salt solution of metals is (0.25-9):1.

3. The method according to claim 1, wherein in step S1, a concentration of the ammonium dihydrogen phosphate solution is 0.5-1.0 mol/L, and a volume ratio of the ammonium dihydrogen phosphate solution to the organic solution in the mixed liquor of phosphate is (1-5):100.

4. The method according to claim 1, wherein in step S1, a ratio of the mass of the surfactant to the volume of the organic solvent is (2-8) g:100 mL.

5. The method according to claim 1, wherein in step S1, the surfactant is selected from the group consisting of CTAB, DBS, SDBS, PEG-400 and a mixture thereof.

6. The method according to claim 1, wherein in step S1, the organic solvent is prepared by mixing cyclohexane and n-butanol at a volume ratio of (8-9):(1-2).

7. The method according to claim 1, wherein in step S2, the base solution has a pH of 8-9, and a system is controlled to have a pH of 8-9 in the reaction.

8. The method according to claim 1, wherein in step S2, the target particle size of the reaction product is 5-15 μm.

9. A lithium manganese iron phosphate, prepared by calcining the ammonium manganese iron phosphate prepared by the method according to claim 1 with a lithium source and a carbon source.

10. A lithium-ion battery comprising the lithium manganese iron phosphate according to claim 9.

11. A lithium manganese iron phosphate, prepared by calcining the ammonium manganese iron phosphate prepared by the method according to claim 2 with a lithium source and a carbon source.

12. A lithium manganese iron phosphate, prepared by calcining the ammonium manganese iron phosphate prepared by the method according to claim 3 with a lithium source and a carbon source.

13. A lithium manganese iron phosphate, prepared by calcining the ammonium manganese iron phosphate prepared by the method according to claim 4 with a lithium source and a carbon source.

14. A lithium manganese iron phosphate, prepared by calcining the ammonium manganese iron phosphate prepared by the method according to claim 5 with a lithium source and a carbon source.

15. A lithium manganese iron phosphate, prepared by calcining the ammonium manganese iron phosphate prepared by the method according to claim 6 with a lithium source and a carbon source.

16. A lithium manganese iron phosphate, prepared by calcining the ammonium manganese iron phosphate prepared by the method according to claim 7 with a lithium source and a carbon source.

17. A lithium manganese iron phosphate, prepared by calcining the ammonium manganese iron phosphate prepared by the method according to claim 8 with a lithium source and a carbon source.

18. A lithium-ion battery comprising the lithium manganese iron phosphate according to claim 11.

19. A lithium-ion battery comprising the lithium manganese iron phosphate according to claim 12.

20. A lithium-ion battery comprising the lithium manganese iron phosphate according to claim 13.
